(19) United States
(12) Patent Application Publication
(10) Pub. No.: US 2024/0406900 A1
(43) Pub. Date: Dec. 5, 2024

(54) TIMING ALIGNMENT IN RRC_INACTIVE

(71) Applicant: Lenovo (Singapore) Pte. Ltd., New Tech Park (SG)

(72) Inventors: Alexander Golitschek Edler von Elbwart, Darmstadt (DE); Joachim Löhr, Wiesbaden (DE); Vijay Nangia, Woodridge, IL (US); Colin Frank, Park Ridge, IL (US)

(21) Appl. No.: 18/697,113

(22) PCT Filed: Sep. 30, 2022
(86) PCT No.: PCT/IB2022/059359

§ 371 Date: Mar. 29, 2024

Related U.S. Application Data
(60) Provisional application No. 63/250,395, filed on Sep. 30, 2021.

(51) Int. Cl. H04W 56/00

(52) U.S. Cl. CPC H04W 56/0045; H04W 56/0015

(57) ABSTRACT

Apparatuses, methods, and systems are disclosed for timing alignment in RRC_INACTIVE. An apparatus (400) includes a processor (405) and memory (410) coupled to the processor (405). The processor (405) is configured to configure the apparatus (400) with small data transmissions while in an inactive state, configure the apparatus (400) with at least one configured grant uplink resource, and maintain transmission timing alignment while the apparatus (400) is in the inactive state based on reception of downlink signals or channels.

### CROSS REFERENCE TO RELATED APPLICATIONS

This application claims the benefit of U.S. Provisional Patent Application No. 63/250,395, entitled “TIMING ALIGNMENT IN RRC_INACTIVE” and filed on Sep. 30, 2021, for Alexander Golitschek Edler von Elbwart, et al., which is incorporated herein by reference.

### FIELD

The subject matter disclosed herein relates generally to wireless communications and more particularly relates timing alignment in RRC_INACTIVE.

### BACKGROUND

In wireless networks, user equipment (“UEs”) may perform small packet transmission while in RRC_INACTIVE state.

### BRIEF SUMMARY

Disclosed are solutions for timing alignment in RRC_INACTIVE. The solutions may be implemented by apparatus, systems, methods, or computer program products.

In one embodiment, a first apparatus includes a processor and memory coupled to the processor. In one embodiment, the processor is configured to configure the apparatus with small data transmissions while in an inactive state, configure the apparatus with at least one configured grant uplink resource, and maintain transmission timing alignment while the apparatus is in the inactive state based on reception of downlink signals or channels.

In one embodiment, a first method configures a network apparatus with small data transmissions while in an inactive state, configures the network apparatus with at least one configured grant uplink resource, and maintains transmission timing alignment while the network apparatus is in the inactive state based on reception of downlink signals or channels.

In one embodiment, a second apparatus includes a processor and a memory coupled to the processor. In one embodiment, the processor is configured to transmit, to a UE, a configuration for configuring the UE with small data transmissions while in an inactive state and transmit, to the UE, a configuration comprising an initial value of a timing alignment timer for maintaining timing alignment in the inactive state.

In one embodiment, a second method transmits, to a UE, a configuration for configuring the UE with small data transmissions while in an inactive state and transmits, to the UE, a configuration comprising an initial value of a timing alignment timer for maintaining timing alignment in the inactive state.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for timing alignment in RRC_INACTIVE;

FIG. 2 depicts a selection of small data transmission (“SDT”) resources based on data volume threshold (“DVT”) and reference signal received power (“RSRP”);

FIG. 3 is a diagram illustrating one embodiment of anew radio (“NR”) protocol stack;

FIG. 4 is a block diagram illustrating one embodiment of a user equipment apparatus that may be used for timing alignment in RRC_INACTIVE;

FIG. 5 is a block diagram illustrating one embodiment of a network apparatus that may be used for timing alignment in RRC_INACTIVE;

FIG. 6 is a flowchart diagram illustrating one embodiment of a method for timing alignment in RRC_INACTIVE; and

FIG. 7 is a flowchart diagram illustrating one embodiment of a method for timing alignment in RRC_INACTIVE.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized.

The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for timing alignment in RRC_INACTIVE. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In Rel-17, there is an enhancement for SDT that enables a UE to transmit (generally small) packets of data while in RRC_INACTIVE state. Staying in RRC_INACTIVE may be beneficial within the network side of the communication system since a transition to RRC_ACTIVE and the according message exchange can be avoided.

In one embodiment, SDT pursues two different tracks to transmit data: a) through configured grant resources or b) through a random access channel (“RACH”) procedure. In one embodiment, using configured grant resources for SDT allows for somewhat larger packets as compared to the RACH procedure, the transmission is more robust, and the transmission can occur on reserved resources where no contention for the medium is required.

However, configured grant resources can only be used if the UE has maintained its uplink timing alignment for the transmission. As seen from TS 38.133, up to Release 16, which is incorporated herein by reference, a UE is required to maintain timing alignment only in the connected state (RRC_CONNECTED) but not in the inactive state (RRC_INACTIVE).

In one embodiment, the subject matter herein presents solutions to maintain uplink timing alignment in RRC_INACTIVE state, including corresponding protocols and information exchange between the UE and the gNB/network.

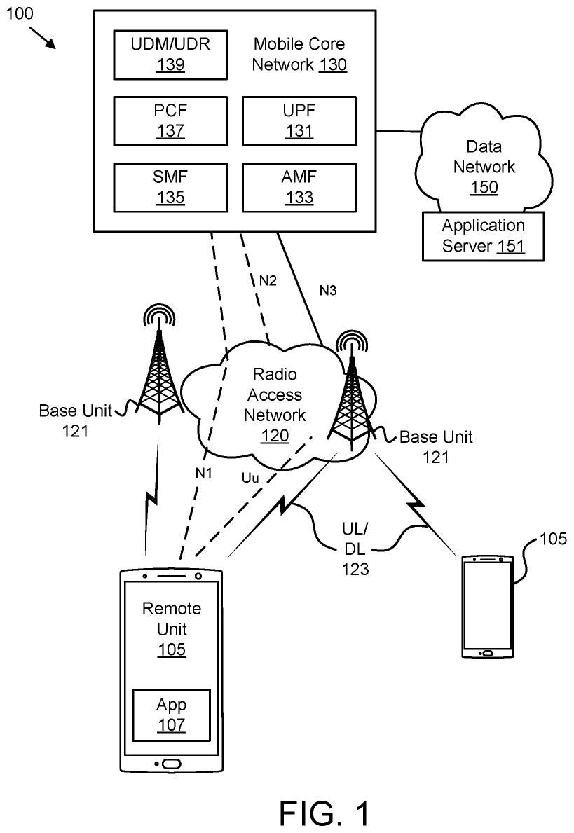

FIG. 1 depicts a wireless communication system 100 supporting timing alignment in RRC_INACTIVE, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as “attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”), a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting timing alignment in RRC_INACTIVE.

As background, up to and including NR Rel-16, a UE is required to maintain timing alignment for its UL transmission when it is in connected state, i.e. in RRC_CONNECTED state. In one embodiment, according to TS 38.133 v. 16.8.0, the UE shall have capability to follow the frame timing change of the reference cell in connected state. The uplink frame transmission takes place (N_{TA}+N_{TAoffset})×T_{c} before the reception of the first detected path (in time) of the corresponding downlink frame from the reference cell. For serving cell(s) in pTAG, UE shall use the SpCell as the reference cell for deriving the UE transmit timing for cells in the pTAG. For serving cell(s) in sTAG, UE shall use any of the activated SCells as the reference cell for deriving the UE transmit timing for the cells in the sTAG. UE initial transmit timing accuracy and gradual timing adjustment requirements are defined in the following requirements.

In the requirements of TS 38.133 v. 16.8.0 clause 7.1.2, the term reference cell on a carrier frequency subject to clear channel assessment (“CCA”) is not available at the UE refers to when at least one signal synchronization block (“SSB”) is configured by gNB, but the first two successive candidate SSB positions for the same SSB index within the discovery burst transmission window are not available during at least one discovery burst transmission window, at the UE due to DL CCA failures at gNB during the last 1280 ms; otherwise the reference cell on the carrier frequency subject to CCA is considered as available at the UE.

In one embodiment, the requirements of TS 38.133 v. 16.8.0 clause 7.1.2 include the UE initial transmission timing error shall be less than or equal to ±Tₑ where the timing error limit value Tₑ is specified in TS 38.133 v. 16.8.0 Table 7.1.2-1. This requirement applies when it is the first transmission in a discontinuous reception (“DRX”) cycle for physical uplink control channel (“PUCCH”), physical uplink shared channel (“PUSCH”) and sounding reference signal (“SRS”), or it is the physical RACH (“PRACH”) transmission, or it is the msgA transmission.

The UE shall meet the Tₑ requirement for an initial transmission provided that at least one SSB is available at the UE during the last 160 ms. The reference point for the UE initial transmit timing control requirement shall be the downlink timing of the reference cell minus (N_{TA}+N_{TA offset})×T_{c}. The downlink timing is defined as the time when the first detected path (in time) of the corresponding downlink frame is received from the reference cell. N_{TA} for PRACH is defined as 0.

(N_{TA}+N_{TA offset})×T_{c} (in T_{c} units) for other channels is the difference between UE transmission timing and the downlink timing immediately after when the last timing advance in clause 7.3 was applied. N_{TA} for other channels is not changed until next timing advance is received. The value of N_{TA offset} depends on the duplex mode of the cell in which the uplink transmission takes place and the frequency range (FR). N_{TA offset} is defined in TS 38.133 v. 16.8.0 Table 7.1.2-2.

TS 38.133 v. 16.8.0 Table 7.1.2-1: Tₑ Timing Error Limit

| | SCS | SCS of | |
|---|---|---|---|
| | of SSB | uplink | |
| Frequency | signals | signals | |
| Range | (kHz) | (kHz) | Tₑ |
| 1 | 15 | 15 | 12*64*T_{c} |
| | | 30 | 10*64*T_{c} |
| | | 60 | 10*64*T_{c} |
| | 30 | 15 | 8*64*T_{c} |
| | | 30 | 8*64*T_{c} |
| | | 60 | 7*64*T_{c} |
| 2 | 120 | 60 | 3.5*64*T_{c} |
| | | 120 | 3.5*64*T_{c} |
| | 240 | 60 | 3*64*T_{c} |
| | | 120 | 3*64*T_{c} |

Note 1:
T_{c} is the basic timing unit defined in TS 38.211

TABLE 7.1.2-2
The Value of N_{TA offset}

| Frequency range and | | |
|---|---|---|
| band of cell used for | N_{TA offset} | |
| uplink transmission | (Unit: T_{C}) | |
| FR1 FDD or TDD band with neither E- | 25600 | (Note 1) |
| UTRA-NR nor NB-IoT-NR coexistence | | |
| case | | |
| FR1 FDD band with E-UTRA-NR and/or | 0 | (Note 1) |
| NB-IoT-NR coexistence case | | |
| FR1 TDD band with E-UTRA-NR and/or | 39936 | (Note 1) |
| NB-IoT-NR coexistence case | | |

| | |
|---|---|
| FR2 | 13792 |

(Note 1): The UE identifies N_{TA offset} based on the information n-TimingAdvanceOffset as specified in TS 38.331. If UE is not provided with the information n-TimingAdvanceOffset, the default value of N_{TA offset} is set as 25600 for FR1 band. In case of multiple UL carriers in the same TAG, UE expects that the same value of n-TimingAdvanceOffset is provided for all the UL carriers according to clause 4.2 in TS 38.213 [3] and the value 39936 of N_{TA offset} can also be provided for a FDD serving cell.
Note 2:
Void

When it is not the first transmission in a DRX cycle or there is no DRX cycle, and when it is the transmission for PUCCH, PUSCH and SRS transmission, the UE shall be capable of changing the transmission timing according to the received downlink frame of the reference cell except when the timing advance in TS 38.133 v. 16.8.0 clause 7.3 is applied.

If the UE uses a reference cell on a carrier frequency subject to CCA for deriving the UE transmit timing, then the UE shall meet all the transmit timing requirements defined in TS 38.133 v. 16.8.0 clause 7.1.2 provided that the reference cell is available at the UE. If the reference cell is not available at the UE on a carrier frequency subject to CCA, then the UE is allowed to transmit in the uplink provided that the UE meets all the transmit timing requirements defined in TS 38.133 v. 16.8.0 clause 7.1.2; otherwise the UE shall not transmit any uplink signal.

If a reference cell on a carrier frequency belonging to the PTAG, which is subject to CCA, is not available at the UE then the UE is allowed to use any of available activated SCell(s) at the UE in PTAG as a new reference cell. If the SCell used as reference cell is deactivated, or becomes not available, the UE is allowed to use another active serving cell in PTAG as new reference cell.

If a reference cell on a carrier frequency belonging to the STAG, which is subject to CCA is not available at the UE then the UE is allowed to use any of available activated SCell(s) at the UE in STAG as a new reference cell.

In one embodiment, directed to gradual timing adjustment, requirements in this section shall apply regardless of whether the reference cell is on a carrier frequency subject to CCA or not. When the transmission timing error between the UE and the reference timing exceeds ±Tₑ then the UE is required to adjust its timing to within ±Tₑ. The reference timing shall be (N_{TA}+N_{TA offset})×T_{c} before the downlink timing of the reference cell. All adjustments made to the UE uplink timing shall follow these rules:
1) The maximum amount of the magnitude of the timing change in one adjustment shall be T_{q}.
2) The minimum aggregate adjustment rate shall be Tₚ per second.
3) The maximum aggregate adjustment rate shall be T_{q} per 200 ms.
   where the maximum autonomous time adjustment step T_{q} and the aggregate adjustment rate Tₚ are specified in TS 38.133 v. 16.8.0 Table 7.1.2.1-1.

TS 38.133 v. 16.8.0 Table 7.1.2.1-1: T_{q} Maximum Autonomous Time
Adjustment Step and Tₚ Minimum Aggregate Adjustment rate

| Frequency | SCS of uplink | | |
|---|---|---|---|
| Range | signals (kHz) | T_{q} | Tₚ |
| 1 | 15 | 5.5*64*T_{c} | 5.5*64*T_{c} |
| | 30 | 5.5*64*T_{c} | 5.5*64*T_{c} |
| | 60 | 5.5*64*T_{c} | 5.5*64*T_{c} |
| 2 | 60 | 2.5*64*T_{c} | 2.5*64*T_{c} |
| | 120 | 2.5*64*T_{c} | 2.5*64*T_{c} |

NOTE:
T_{c} is the basic timing unit defined in TS 38.211

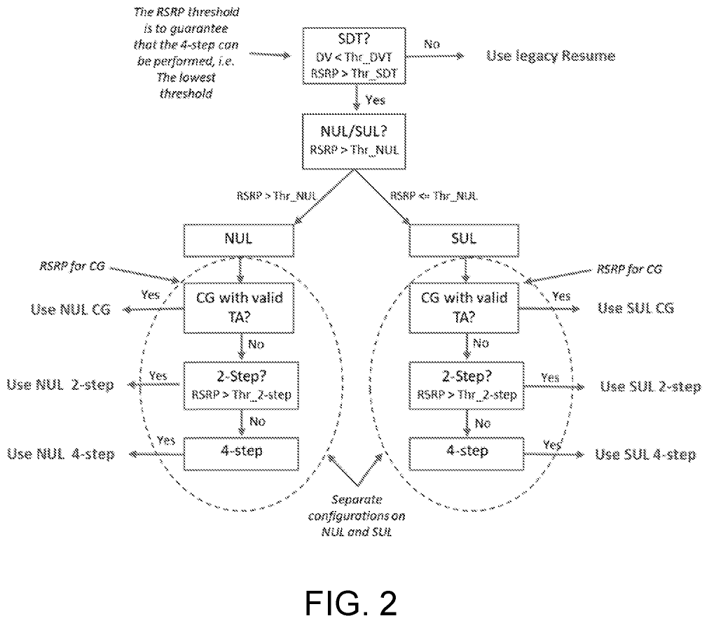

In the ongoing Rel-17 SDT work item, a UE in RRC_INACTIVE follows the following steps if it has data to transmit and SDT enabled, as shown in FIG. 2.

As can be seen from the flowchart, after passing the check of DVT and RSRP thresholds, a UE can initiate an SDT transmission on NUL/SUL. The generally preferred solution is to use configured grant (“CG”) resources, which can only be employed with a valid TA. If the TA is invalid, a 2-step or 4-step RACH procedure is initiated.

Therefore, according to prior art, a UE is not maintaining timing alignment when it is in RRC_INACTIVE, therefore after the time alignment timer (“TAT”) expires, the UE will not be able to use CG resources for SDT.

According to a first embodiment of the proposed solution, a UE maintains its timing alignment when it is in inactive state, e.g., in RRC_INACTIVE. In an implementation of the embodiment, the UE maintains its timing alignment when it is in inactive state and is being configured with maintaining its timing alignment in inactive state, e.g., for purposes of small data transmission. In an implementation of the embodiment, the UE maintains its timing alignment when it is in inactive state and is being configured for data transmission in inactive state (such as SDT). In one implementation, the UE maintains its uplink timing alignment in RRC_INACTIVE when being configured with CG-SDT resources and a TAT timer for the purpose of CG-SDT transmission in RRC_INACTIVE, e.g., SDT-TAT timer and CG-SDT may be configured within the RRCRelease message. In another implementation, the UE maintains its uplink timing alignment in RRC_INACTIVE when being configured with CG-SDT resources in RRC_INACTIVE, e.g., CG-SDT may be configured within the RRCRelease message, and the TAT for the purpose of CG-SDT is the same timer as the TAT used in connected state. In an implementation of the embodiment, the UE maintains its timing alignment when it is in inactive state and is being configured for data transmission in inactive state (such as SDT) and is being configured with maintaining its timing alignment in inactive state.

According to an embodiment, the TAT used for purposes of determining timing alignment for data transmissions in inactive state (e.g., called TATinactive) is a different timer than the TAT used in connected state. In an implementation, the RRCRelease message includes an initial value for the TATinactive. Accordingly, in an embodiment, a network entity transmits a RRCRelease message including an initial value for the TATinactive. In one implementation, the initial value for the TATinactive is selected from a set of possible values for TATinactive that is different than the set of possible values for TAT used in connected state. The number of elements in the two sets may be the same.

According to an embodiment, a timing advance command received in inactive state resets or restarts the TATinactive. In an implementation, the timing advance command received in an inactive state resets additionally the TAT used in connected state. In one implementation, the timing advanced command (TA command) is received after the UE transmits a CG-based PUSCH transmission carrying RRC Resume Request (and UL payload) as part of the CG based SDT procedure in RRC_INACTIVE and prior to receiving a subsequent RRCRelease message with Suspend Indication.

According to one embodiment, a UE in RRC_INACTIVE (gradually) adjusts its uplink timing when there is a DL timing difference observed by the UE. In one implementation a UE in RRC_INACTIVE autonomously adjusts its uplink timing in order to follow the DL timing reference for cases when the UE in RRC_INACTIVE is configured for SDT transmission, e.g., a certain subset of the radio bearers of the UE are configured as SDT-bearer. In one specific implementation a UE in RRC_INACTIVE autonomously adjusts its uplink timing when being configured with CG-SDT resources. In another specific implementation a UE in RRC_INACTIVE autonomously adjusts its uplink timing when the UE determines it needs to maintain its uplink timing alignment in RRC_INACTIVE. UE is adjusting its timing error to be within the timing error limit value ±Tₑ when the transmission timing error between the UE transmission time and a reference timing exceeds ±Tₑ.

To keep the transmission timing error less than or equal to Tₑ or within ±Tₑ, the UE adjusts its transmission timing accordingly. The motivation to apply a gradual timing adjustment is to counter sudden DL timing changes due to something like an instant blockage of the best propagation etc. There is, according to one implementation, a minimum aggregate adjustment rate which requires the UE to adjust its timing by at least Tₚ per second and a maximum aggregate adjustment rate requiring the UE to adjust its timing by at most T_{q} per 200 ms. The T_{q} and Tₚ requirements are essentially a function of the timing error, with an aim to make sure that the UL timing follows the DL timing reference. UE may maintain or continue to adjust N_{TA} upon being released to RRC_INACTIVE for cases when UE is configured for SDT transmission(s).

According to one implementation of the embodiment, the UE is provided with a set of RRC_INACTIVE specific parameters to be applied for the (gradual) timing adjustment in RRC_INACTVE. In one implementation, the set of parameters is comprised of a timing error limit value Tₑ, a maximum amount of the magnitude of the timing change T_{q} in one adjustment and a minimum aggregate adjustment rate Tₚ per second. The set of RRC_INACTIVE specific parameter may be preconfigured and/or fixed in standards or configured within the RRCRelease message. The set of RRC_INACTIVE specific parameters may be a function of or based on the frequency range and the subcarrier spacing of the UL carrier/bandwidth part or the CG resource.

According to one embodiment, a UE in RRC_INACTIVE autonomously updates/changes its N_{TA} accordingly if the received downlink timing changes, e.g., downlink timing of the reference cell. The UE may change the stored N_{TA} value based on the received downlink timing changes. In one implementation a UE in RRC_INACTIVE autonomously updates/changes its N_{TA} when being configured with CG-SDT resources in RRC_INACTIVE.

According to one example, it is assumed that a UE in RRC_INACTIVE has a N_{TA} value, e.g., last, or most-recent N_{TA} value used in RRC_CONNECTED before being released to RRC_INACTIVE. The UE stores and maintains N_{TA} when being released to RRC_INACTIVE. If the UE moves further towards the cell edge, the received downlink timing may arrive at a certain amount of time later, e.g., one time unit later in this example, than the previous reference downlink timing. The UE may change the N_{TA} to N_{TA,adjusted} accordingly based on the new downlink timing. Specifically, in this example, the N_{TA,adjusted} may be equal to (N_{TA}+one time unit)—the change in the DL transmission timing—in order to keep the UE transmission timing approximately the same relative to the reference timing. In one example, when the same TAT is used in RRC_CONNECTED and RRC_INACTIVE, the TAT is not restarted and continues to run when the UE is released to RRC_INACTIVE. In another example, when a different TAT is used in RRC_CONNECTED and RRC_INACTIVE, the TATinactive running value is set to be the same as the last/most-recent TAT running value in RRC_CONNECTED before the UE is released to RRC_INACTIVE.

According to one embodiment, a UE in RRC_INACTIVE maintains a N_{TA} value and transmits a CG-based PUSCH transmission carrying RRC Resume Request (and UL payload) as part of the CG based SDT procedure. Prior to receiving any subsequent RRCRelease with Suspend Indication, if the UE receives a RRC Resume message and transitions to RRC_CONNECTED, it is assumed that a UE in RRC_CONNECTED has a N_{TA} value that is same as the last or most-recent N_{TA} value used in RRC_INACTIVE before being transitioned to RRC_CONNECTED. In one example, when the same TAT is used in RRC_CONNECTED, the TAT is not restarted and continues to run when the UE is transitioned to RRC_CONNECTED. In another example, when different TAT is used in RRC_INACTIVE and RRC_CONNECTED and RRC_INACTIVE, the TAT running value used in connected state is set to be the same as the last/most-recent TATinactive running value in RRC_INACTIVE before the UE is transitioned to RRC_CONNECTED.

According to an embodiment, if a UE in inactive state uses a reference cell for deriving the UE transmit timing, then the UE shall meet all the transmit timing requirements provided that the reference cell is available at the UE. If the reference cell is not available at the UE in inactive state, then the UE is allowed to transmit in the uplink provided that the UE meets all the transmit timing requirements; otherwise, the UE shall not transmit any uplink signal.

According to an implementation of the embodiment, a reference cell for a UE in inactive state is considered not available at the UE when at least one SSB is configured by gNB, but a first number of successive candidate SSB positions for the same SSB index are not received by the UE during a first time interval; otherwise, the reference cell for a UE in inactive state is considered as available at the UE. An exemplary value for the first number of successive candidate SSB positions for the same SSB index is 2, and an exemplary first time interval spans the most recent 1280 ms.

According to an implementation of the embodiment, a reference cell for a UE in inactive state is considered available at the UE when at least one PO is configured by gNB, and at least a first number of successive PO candidates are received by the UE during a second time interval; otherwise, the reference cell for a UE in inactive state is considered as not available at the UE. An exemplary value for the first number of successive PO candidates is 2, and an exemplary second time interval spans the most recent 1280 ms.

According to an embodiment, a UE indicates to the network whether it is capable of maintaining timing alignment in inactive state. In an implementation, this capability is indicated if the UE is capable of data transmission (such as SDT) in inactive state.

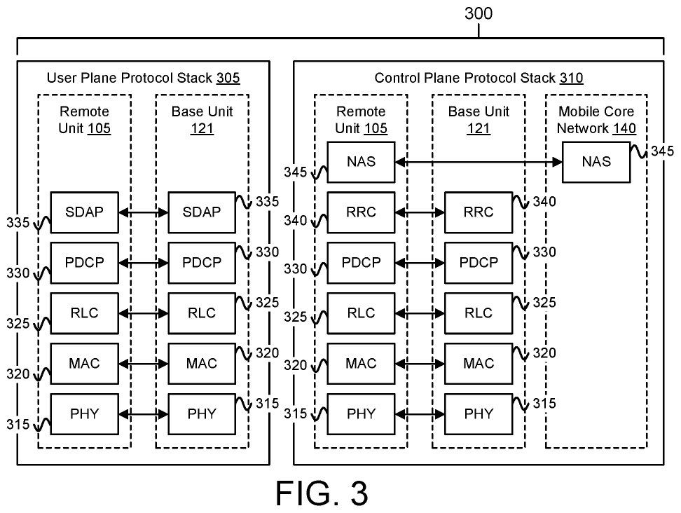

FIG. 3 depicts a NR protocol stack 300, according to embodiments of the disclosure. While FIG. 3 shows the remote unit 105, the base unit 121 and the mobile core network 130, these are representative of a set of UEs interacting with a RAN node and a NF (e.g., AMF) in a core network. As depicted, the protocol stack 300 comprises a User Plane protocol stack 305 and a Control Plane protocol stack 310. The User Plane protocol stack 305 includes a physical (“PHY”) layer 315, a Medium Access Control (“MAC”) sublayer 320, a Radio Link Control (“RLC”) sublayer 325, a Packet Data Convergence Protocol (“PDCP”) sublayer 330, and Service Data Adaptation Protocol (“SDAP”) layer 335. The Control Plane protocol stack 310 also includes a physical layer 315, a MAC sublayer 320, a RLC sublayer 325, and a PDCP sublayer 330. The Control Place protocol stack 310 also includes a Radio Resource Control (“RRC”) layer and a Non-Access Stratum (“NAS”) layer 345.

The AS protocol stack for the Control Plane protocol stack 310 consists of at least RRC, PDCP, RLC and MAC sublayers, and the physical layer. The AS protocol stack for the User Plane protocol stack 305 consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer 340 and the NAS layer 345 for the control plane and includes, e.g., an Internet Protocol (“IP”) layer or PDU Layer (note depicted) for the user plane. L1 and L2 are referred to as “lower layers” such as PUCCH/PUSCH or MAC CE, while L3 and above (e.g., transport layer, application layer) are referred to as “higher layers” or “upper layers” such as RRC.

The physical layer 315 offers transport channels to the MAC sublayer 320. The MAC sublayer 320 offers logical channels to the RLC sublayer 325. The RLC sublayer 325 offers RLC channels to the PDCP sublayer 330. The PDCP sublayer 330 offers radio bearers to the SDAP sublayer 335 and/or RRC layer 340. The SDAP sublayer 335 offers QoS flows to the mobile core network 130 (e.g., 5GC). The RRC layer 340 provides for the addition, modification, and release of Carrier Aggregation and/or Dual Connectivity. The RRC layer 340 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

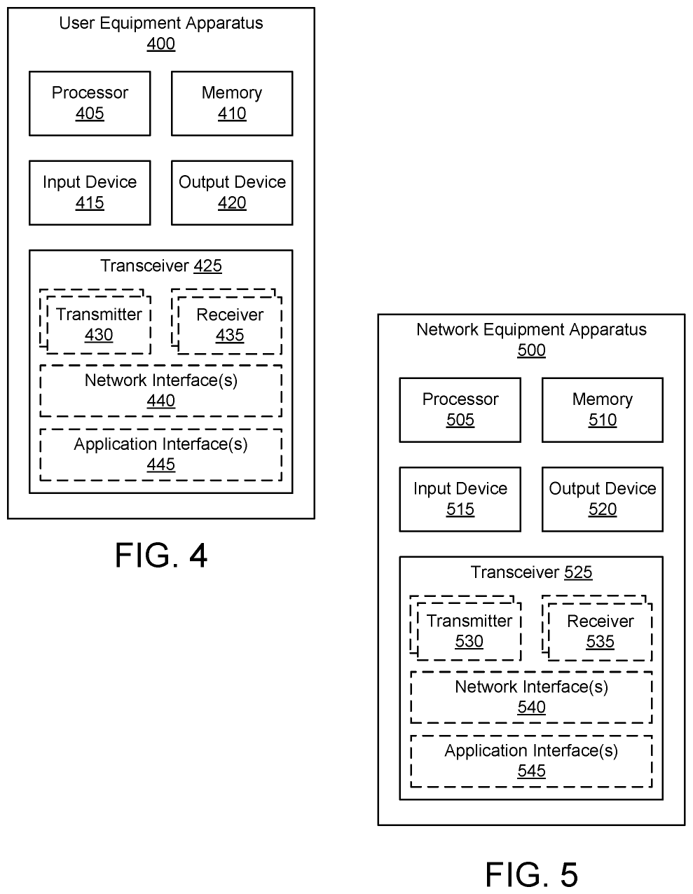

FIG. 4 depicts a user equipment apparatus 400 that may be used for timing alignment in RRC_INACTIVE, according to embodiments of the disclosure. In various embodiments, the user equipment apparatus 400 is used to implement one or more of the solutions described above. The user equipment apparatus 400 may be one embodiment of a UE, such as the remote unit 105 and/or the UE 205, as described above. Furthermore, the user equipment apparatus 400 may include a processor 405, a memory 410, an input device 415, an output device 420, and a transceiver 425. In some embodiments, the input device 415 and the output device 420 are combined into a single device, such as a touchscreen. In certain embodiments, the user equipment apparatus 400 may not include any input device 415 and/or output device 420. In various embodiments, the user equipment apparatus 400 may include one or more of: the processor 405, the memory 410, and the transceiver 425, and may not include the input device 415 and/or the output device 420.

As depicted, the transceiver 425 includes at least one transmitter 430 and at least one receiver 435. Here, the transceiver 425 communicates with one or more base units 121. Additionally, the transceiver 425 may support at least one network interface 440 and/or application interface 445. The application interface(s) 445 may support one or more APIs. The network interface(s) 440 may support 3GPP reference points, such as Uu and PC5. Other network interfaces 440 may be supported, as understood by one of ordinary skill in the art.

The processor 405, in one embodiment, may include any known controller capable of executing computer-readable instructions and/or capable of performing logical operations. For example, the processor 405 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 405 executes instructions stored in the memory 410 to perform the methods and routines described herein. The processor 405 is communicatively coupled to the memory 410, the input device 415, the output device 420, and the transceiver 425. In certain embodiments, the processor 405 may include an application processor (also known as “main processor”) which manages application-domain and operating system (“OS”) functions and a baseband processor (also known as “baseband radio processor”) which manages radio functions.

The memory 410, in one embodiment, is a computer readable storage medium. In some embodiments, the memory 410 includes volatile computer storage media. For example, the memory 410 may include a RAM, including dynamic RAM (“DRAM”), synchronous dynamic RAM (“SDRAM”), and/or static RAM (“SRAM”). In some embodiments, the memory 410 includes non-volatile computer storage media. For example, the memory 410 may include a hard disk drive, a flash memory, or any other suitable non-volatile computer storage device. In some embodiments, the memory 410 includes both volatile and non-volatile computer storage media.

In some embodiments, the memory 410 stores data related to timing alignment in RRC_INACTIVE. For example, the memory 410 may store parameters, configurations, resource assignments, policies, and the like as described above. In certain embodiments, the memory 410 also stores program code and related data, such as an operating system or other controller algorithms operating on the user equipment apparatus 400, and one or more software applications.

The input device 415, in one embodiment, may include any known computer input device including a touch panel, a button, a keyboard, a stylus, a microphone, or the like. In some embodiments, the input device 415 may be integrated with the output device 420, for example, as a touchscreen or similar touch-sensitive display. In some embodiments, the input device 415 includes a touchscreen such that text may be input using a virtual keyboard displayed on the touchscreen and/or by handwriting on the touchscreen. In some embodiments, the input device 415 includes two or more different devices, such as a keyboard and a touch panel.

The output device 420, in one embodiment, is designed to output visual, audible, and/or haptic signals. In some embodiments, the output device 420 includes an electronically controllable display or display device capable of outputting visual data to a user. For example, the output device 420 may include, but is not limited to, an LCD display, an LED display, an OLED display, a projector, or similar display device capable of outputting images, text, or the like to a user. As another, non-limiting, example, the output device 420 may include a wearable display separate from, but communicatively coupled to, the rest of the user equipment apparatus 400, such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

In certain embodiments, the output device 420 includes one or more speakers for producing sound. For example, the output device 420 may produce an audible alert or notification (e.g., a beep or chime). In some embodiments, the output device 420 includes one or more haptic devices for producing vibrations, motion, or other haptic feedback. In some embodiments, all or portions of the output device 420 may be integrated with the input device 415. For example, the input device 415 and output device 420 may form a touchscreen or similar touch-sensitive display. In other embodiments, the output device 420 may be located near the input device 415.

The transceiver 425 includes at least transmitter 430 and at least one receiver 435. The transceiver 425 may be used to provide UL communication signals to a base unit 121 and to receive DL communication signals from the base unit 121, as described herein. Similarly, the transceiver 425 may be used to transmit and receive SL signals (e.g., V2X communication), as described herein. Although only one transmitter 430 and one receiver 435 are illustrated, the user equipment apparatus 400 may have any suitable number of transmitters 430 and receivers 435. Further, the transmitter(s) 430 and the receiver(s) 435 may be any suitable type of transmitters and receivers. In one embodiment, the transceiver 425 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 425, transmitters 430, and receivers 435 may be implemented as physically separate components that access a shared hardware resource and/or software resource, such as for example, the network interface 440.

In various embodiments, one or more transmitters 430 and/or one or more receivers 435 may be implemented and/or integrated into a single hardware component, such as a multi-transceiver chip, a system-on-a-chip, an ASIC, or other type of hardware component. In certain embodiments, one or more transmitters 430 and/or one or more receivers 435 may be implemented and/or integrated into a multi-chip module. In some embodiments, other components such as the network interface 440 or other hardware components/circuits may be integrated with any number of transmitters 430 and/or receivers 435 into a single chip. In such embodiment, the transmitters 430 and receivers 435 may be logically configured as a transceiver 425 that uses one more common control signals or as modular transmitters 430 and receivers 435 implemented in the same hardware chip or in a multi-chip module.

In one embodiment, the processor 405 is configured to configure the apparatus 400 with small data transmissions while in an inactive state, configure the apparatus 400 with at least one configured grant uplink resource, and maintain transmission timing alignment while the apparatus 400 is in the inactive state based on reception of downlink signals or channels.

In one embodiment, maintaining the transmission timing alignment comprises detecting a change of a received downlink transmission timing, determining an amount of change of time of the received downlink transmission timing, and adjusting a timing advance based on the determined amount of change of time.

In one embodiment, the processor 405 is configured to configure the apparatus 400 with an initial value for a timing alignment timer applicable for maintaining the timing alignment in the inactive state.

In one embodiment, the processor 405 is configured to reset a timing alignment timer for the apparatus 400 to an initial value in response to receiving a timing advance command while in the inactive state.

In one embodiment, the timing alignment timer that is used for determining timing alignment for data transmissions while the apparatus 400 is in the inactive state is different from a second timing alignment timer that is used for determining timing alignment for data transmissions while the apparatus 400 is in a connected state.

In one embodiment, the processor 405 is configured to reset the second timing alignment timer that is used for determining timing alignment for data transmissions while the apparatus 400 is in the connected state in response to receiving the timing advance command.

In one embodiment, the processor 405 is configured to gradually adjust uplink timing for the apparatus 400 in response to detecting a timing alignment difference while in the inactive state.

In one embodiment, the processor 405 is configured to autonomously adjust the uplink timing to correspond to a downlink timing reference for the apparatus 400 while the apparatus 400 is in the inactive state and a subset of radio bearers for the apparatus 400 are configured as small data transmission bearers.

In one embodiment, the processor 405 is configured to autonomously adjust the uplink timing in response to configuring the apparatus 400 with configured grant small data transmission resources.

In one embodiment, the processor 405 is configured to adjust the transmission timing alignment such that a timing error is within a timing error threshold.

In one embodiment, the processor 405 is configured to receive at least one timing alignment parameter for gradually adjusting the timing alignment while in the inactive state.

In one embodiment, the processor 405 is configured to adjust an N_{TA} value in response to the apparatus 400 detecting a change in the reception timing of a downlink transmission.

In one embodiment, in response to a same timing alignment timer being used for both connected and inactive states, the processor 405 is configured to not reset the timer to an initial value in response to the apparatus 400 being released to the inactive state but instead keeps the timer at its value at the time of being released, from which further on the timer may continue to decrement.

FIG. 5 depicts one embodiment of a network apparatus 500 that may be used for timing alignment in RRC_INACTIVE, according to embodiments of the disclosure. In some embodiments, the network apparatus 500 may be one embodiment of a RAN node and its supporting hardware, such as the base unit 121 and/or gNB, described above. Furthermore, network apparatus 500 may include a processor 505, a memory 510, an input device 515, an output device 520, and a transceiver 525. In certain embodiments, the network apparatus 500 does not include any input device 515 and/or output device 520.

As depicted, the transceiver 525 includes at least one transmitter 530 and at least one receiver 535. Here, the transceiver 525 communicates with one or more remote units 105. Additionally, the transceiver 525 may support at least one network interface 540 and/or application interface 545. The application interface(s) 545 may support one or more APIs. The network interface(s) 540 may support 3GPP reference points, such as Uu, N1, N2, N3, N5, N6 and/or N7 interfaces. Other network interfaces 540 may be supported, as understood by one of ordinary skill in the art.

When implementing an NEF, the network interface(s) 540 may include an interface for communicating with an application function (i.e., N5) and with at least one network function (e.g., UDR, SFC function, UPF) in a mobile communication network, such as the mobile core network 130.

The processor 505, in one embodiment, may include any known controller capable of executing computer-readable instructions and/or capable of performing logical operations. For example, the processor 505 may be a microcontroller, a microprocessor, a CPU, a GPU, an auxiliary processing unit, an FPGA, a DSP, a co-processor, an application-specific processor, or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525. In certain embodiments, the processor 505 may include an application processor (also known as “main processor”) which manages application-domain and OS functions and a baseband processor (also known as “baseband radio processor”) which manages radio function. In various embodiments, the processor 505 controls the network apparatus 500 to implement the above described network entity behaviors (e.g., of the gNB) for timing alignment in RRC_INACTIVE.

The memory 510, in one embodiment, is a computer readable storage medium. In some embodiments, the memory 510 includes volatile computer storage media. For example, the memory 510 may include a RAM, including DRAM, SDRAM, and/or SRAM. In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data relating to timing alignment in RRC_INACTIVE. For example, the memory 510 may store parameters, configurations, resource assignments, policies, and the like as described above. In certain embodiments, the memory 510 also stores program code and related data, such as an OS or other controller algorithms operating on the network apparatus 500, and one or more software applications.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, may include any known electronically controllable display or display device. The output device 520 may be designed to output visual, audible, and/or haptic signals. In some embodiments, the output device 520 includes an electronic display capable of outputting visual data to a user. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, all or portions of the output device 520 may be located near the input device 515.

As discussed above, the transceiver 525 may communicate with one or more remote units and/or with one or more interworking functions that provide access to one or more PLMNs. The transceiver 525 may also communicate with one or more network functions (e.g., in the mobile core network 80). The transceiver 525 operates under the control of the processor 505 to transmit messages, data, and other signals and also to receive messages, data, and other signals. For example, the processor 505 may selectively activate the transceiver (or portions thereof) at particular times in order to send and receive messages.

The transceiver 525 may include one or more transmitters 530 and one or more receivers 535. In certain embodiments, the one or more transmitters 530 and/or the one or more receivers 535 may share transceiver hardware and/or circuitry. For example, the one or more transmitters 530 and/or the one or more receivers 535 may share antenna(s), antenna tuner(s), amplifier(s), filter(s), oscillator(s), mixer(s), modulator/demodulator(s), power supply, and the like. In one embodiment, the transceiver 525 implements multiple logical transceivers using different communication protocols or protocol stacks, while using common physical hardware.

In one embodiment, the processor 505 is configured to transmit, to a UE, a configuration for configuring the UE with small data transmissions while in an inactive state and transmit, to the UE, a configuration comprising an initial value of a timing alignment timer for maintaining timing alignment in the inactive state.

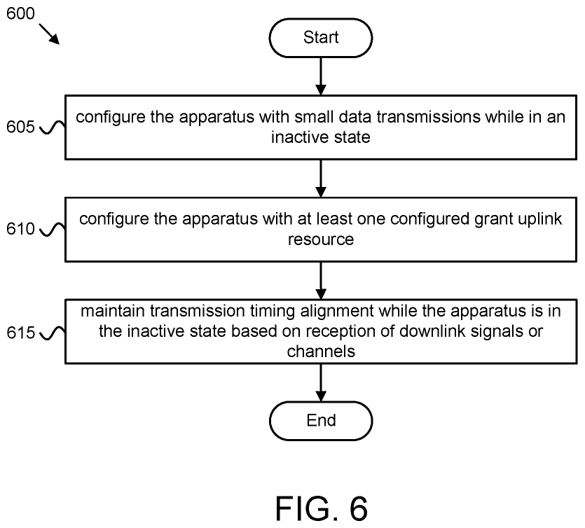

FIG. 6 is a flowchart diagram of a method 600 for timing alignment in RRC_INACTIVE. The method 600 may be performed by a UE as described herein, for example, the remote unit 105 and/or the user equipment apparatus 400. In some embodiments, the method 600 may be performed by a processor executing program code, for example, a microcontroller, a microprocessor, a CPU, a GPU, an auxiliary processing unit, a FPGA, or the like.

In one embodiment, the method 600 begins and configures 605 the apparatus with small data transmissions while in an inactive state. In one embodiment, the method 600 configures 610 the apparatus with at least one configured grant uplink resource. In one embodiment, the method 600 maintains 615 transmission timing alignment while the apparatus is in the inactive state based on reception of downlink signals or channels, and the method 600 ends.

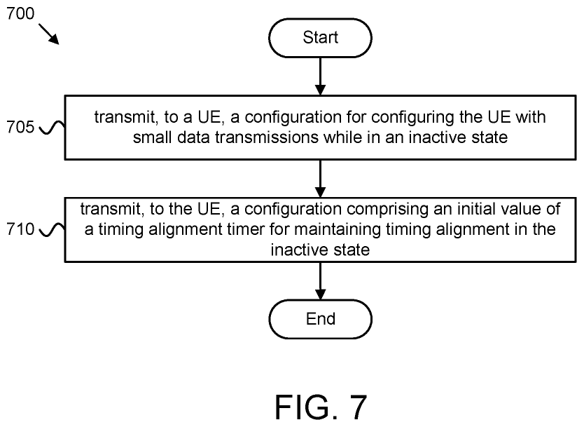

FIG. 7 is a flowchart diagram of a method 700 for timing alignment in RRC_INACTIVE. The method 700 may be performed by a network entity as described herein, for example, the base unit 121, the gNB, and/or the network equipment apparatus 500. In some embodiments, the method 700 may be performed by a processor executing program code, for example, a microcontroller, a microprocessor, a CPU, a GPU, an auxiliary processing unit, a FPGA, or the like.

In one embodiment, the method 700 transmits 705, to a UE, a configuration for configuring the UE with small data transmissions while in an inactive state. In one embodiment, the method 700 transmits 710 a configuration comprising an initial value of a timing alignment timer for maintaining timing alignment in the inactive state, and the method 700 ends.

A first apparatus is disclosed for timing alignment in RRC_INACTIVE. The first apparatus may include a UE as described herein, for example, the remote unit 105 and/or the user equipment apparatus 400. In some embodiments, the first apparatus may include a processor executing program code, for example, a microcontroller, a microprocessor, a CPU, a GPU, an auxiliary processing unit, a FPGA, or the like.

In one embodiment, the first apparatus includes a processor and memory coupled to the processor. In one embodiment, the processor is configured to configure the apparatus with small data transmissions while in an inactive state, configure the apparatus with at least one configured grant uplink resource, and maintain transmission timing alignment while the apparatus is in the inactive state based on reception of downlink signals or channels.

In one embodiment, maintaining the transmission timing alignment comprises detecting a change of a received downlink transmission timing, determining an amount of change of time of the received downlink transmission timing, and adjusting a timing advance based on the determined amount of change of time.

In one embodiment, the processor is configured to configure the apparatus with an initial value for a timing alignment timer applicable for maintaining the timing alignment in the inactive state.

In one embodiment, the processor is configured to reset a timing alignment timer for the apparatus to an initial value in response to receiving a timing advance command while in the inactive state.

In one embodiment, the timing alignment timer that is used for determining timing alignment for data transmissions while the apparatus is in the inactive state is different from a second timing alignment timer that is used for determining timing alignment for data transmissions while the apparatus is in a connected state.

In one embodiment, the processor is configured to reset the second timing alignment timer that is used for determining timing alignment for data transmissions while the apparatus is in the connected state in response to receiving the timing advance command.

In one embodiment, the processor is configured to gradually adjust uplink timing for the apparatus in response to detecting a timing alignment difference while in the inactive state.

In one embodiment, the processor is configured to autonomously adjust the uplink timing to correspond to a downlink timing reference for the apparatus while the apparatus is in the inactive state and a subset of radio bearers for the apparatus are configured as small data transmission bearers.

In one embodiment, the processor is configured to autonomously adjust the uplink timing in response to configuring the apparatus with configured grant small data transmission resources.

In one embodiment, the processor is configured to adjust the transmission timing alignment such that a timing error is within a timing error threshold.

In one embodiment, the processor is configured to receive at least one timing alignment parameter for gradually adjusting the timing alignment while in the inactive state.

In one embodiment, the processor is configured to adjust an N_{TA} value in response to the apparatus detecting a change in the reception timing of a downlink transmission.

In one embodiment, in response to a same timing alignment timer being used for both connected and inactive states, the processor is configured to not reset the timer to an initial value in response to the apparatus being released to the inactive state but instead keeps the timer at its value at the time of being released, from which further on the timer may continue to decrement.

A first method is disclosed for timing alignment in RRC_INACTIVE. The first method may be performed by a UE as described herein, for example, the remote unit 105 and/or the user equipment apparatus 400. In some embodiments, the first method may be performed by a processor executing program code, for example, a microcontroller, a microprocessor, a CPU, a GPU, an auxiliary processing unit, a FPGA, or the like.

In one embodiment, the first method configures a network apparatus with small data transmissions while in an inactive state, configures the network apparatus with at least one configured grant uplink resource, and maintains transmission timing alignment while the network apparatus is in the inactive state based on reception of downlink signals or channels.

In one embodiment, maintaining the transmission timing alignment comprises detecting a change of a received downlink transmission timing, determining an amount of change of time of the received downlink transmission timing, and adjusting a timing advance based on the determined amount of change of time.

In one embodiment, the first method configures the network apparatus with an initial value for a timing alignment timer applicable for maintaining the timing alignment in the inactive state.

In one embodiment, the first method resets a timing alignment timer for the network apparatus to an initial value in response to receiving a timing advance command while in the inactive state.

In one embodiment, the timing alignment timer that is used for determining timing alignment for data transmissions while the network apparatus is in the inactive state is different from a second timing alignment timer that is used for determining timing alignment for data transmissions while the network apparatus is in a connected state.

In one embodiment, the first method resets the second timing alignment timer that is used for determining timing alignment for data transmissions while the network apparatus is in the connected state in response to receiving the timing advance command.

In one embodiment, the first method gradually adjusts uplink timing for the network apparatus in response to detecting a timing alignment difference while in the inactive state.

In one embodiment, the first method autonomously adjusts the uplink timing to correspond to a downlink timing reference for the network apparatus while the network apparatus is in the inactive state and a subset of radio bearers for the network apparatus are configured as small data transmission bearers.

In one embodiment, the first method autonomously adjusts the uplink timing in response to configuring the network apparatus with configured grant small data transmission resources.

In one embodiment, the first method adjusts the transmission timing alignment such that a timing error is within a timing error threshold.

In one embodiment, the first method receives at least one timing alignment parameter for gradually adjusting the timing alignment while in the inactive state.

In one embodiment, the first method adjusts an N_{TA} value in response to the network apparatus detecting a change in the reception timing of a downlink transmission.

In one embodiment, in response to a same timing alignment timer being used for both connected and inactive states, the first method does not reset the timer to an initial value in response to the network apparatus being released to the inactive state but instead keeps the timer at its value at the time of the release, from which further on the timer may continue to decrement.

A second apparatus is disclosed for timing alignment in RRC_INACTIVE. The second apparatus may include a network entity as described herein, for example, the base unit 121, the gNB, and/or the network equipment apparatus 500. In some embodiments, the second apparatus may include a processor executing program code, for example, a microcontroller, a microprocessor, a CPU, a GPU, an auxiliary processing unit, a FPGA, or the like.

In one embodiment, the second apparatus includes a processor and a memory coupled to the processor. In one embodiment, the processor is configured to transmit, to a UE, a configuration for configuring the UE with small data transmissions while in an inactive state and transmit, to the UE, a configuration comprising an initial value of a timing alignment timer for maintaining timing alignment in the inactive state.

A second method is disclosed for timing alignment in RRC_INACTIVE. The second method may be performed by a network entity as described herein, for example, the base unit 121, the gNB, and/or the network equipment apparatus 500. In some embodiments, the second method may be performed by a processor executing program code, for example, a microcontroller, a microprocessor, a CPU, a GPU, an auxiliary processing unit, a FPGA, or the like.

In one embodiment, the second method transmits, to a UE, a configuration for configuring the UE with small data transmissions while in an inactive state and transmits, to the UE, a configuration comprising an initial value of a timing alignment timer for maintaining timing alignment in the inactive state.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a processor,
a memory coupled to the processor, the processor configured to:
configure the apparatus with small data transmissions while in an inactive state;
configure the apparatus with at least one configured grant uplink resource; and
maintain transmission timing alignment while the apparatus is in the inactive state based on reception of downlink signals or channels.

2. The apparatus of claim 1, wherein maintaining the transmission timing alignment comprises detecting a change of a received downlink transmission timing, determining an amount of change of time of the received downlink transmission timing, and adjusting a timing advance based on the determined amount of change of time.

3. The apparatus of claim 1, wherein the processor is configured to configure the apparatus with an initial value for a timing alignment timer applicable for maintaining the timing alignment in the inactive state.

4. The apparatus of claim 3, wherein the processor is configured to reset a timing alignment timer for the apparatus to an initial value in response to receiving a timing advance command while in the inactive state.

5. The apparatus of claim 3, wherein the timing alignment timer that is used for determining timing alignment for data transmissions while the apparatus is in the inactive state is different from a second timing alignment timer that is used for determining timing alignment for data transmissions while the apparatus is in a connected state.

6. The apparatus of claim 5, wherein the processor is configured to reset the second timing alignment timer that is used for determining timing alignment for data transmissions while the apparatus is in the connected state in response to receiving the timing advance command.

7. The apparatus of claim 1, wherein the processor is configured to gradually adjust uplink timing for the apparatus in response to detecting a timing alignment difference while in the inactive state.

8. The apparatus of claim 7, wherein the processor is configured to autonomously adjust the uplink timing to correspond to a downlink timing reference for the apparatus while the apparatus is in the inactive state and a subset of radio bearers for the apparatus are configured as small data transmission bearers.

9. The apparatus of claim 7, wherein the processor is configured to autonomously adjust the uplink timing in response to configuring the apparatus with configured grant small data transmission resources.

10. The apparatus of claim 1, wherein the processor is configured to adjust the transmission timing alignment such that a timing error is within a timing error threshold.

11. The apparatus of claim 1, wherein the processor is configured to receive at least one timing alignment parameter for gradually adjusting the timing alignment while in the inactive state.

12. The apparatus of claim 1, wherein the processor is configured to adjust an N_{TA} value in response to the apparatus detecting a change in the reception timing of a downlink transmission.

13. The apparatus of claim 12, wherein, in response to a same timing alignment timer being used for both connected and inactive states, the processor is configured to not reset the timer in response to the apparatus being released to the inactive state.

14. A method, comprising:
configuring a network apparatus with small data transmissions while in an inactive state;
configuring the network apparatus with at least one configured grant uplink resource; and
maintaining transmission timing alignment while the network apparatus is in the inactive state based on reception of downlink signals or channels.

15. An apparatus, comprising:
a processor; and
a memory coupled to the processor, the processor configured to cause the apparatus to:
transmit, to a user equipment (“UE”), a configuration for configuring the UE with small data transmissions while in an inactive state; and
transmit, to the UE, a configuration comprising an initial value of a timing alignment timer for maintaining timing alignment in the inactive state.
